(19) United States
(12) Patent Application Publication
(10) Pub. No.: US 2026/0229947 A1
(43) Pub. Date: Aug. 6, 2026

(54) ROTATING ELECTRICAL MACHINE

(71) Applicant: AISIN CORPORATION, Kariya (JP)

(72) Inventors: Shunsuke KOYABU, Kariya-shi (JP); Hiroaki YABUI, Kariya-shi (JP)

(73) Assignee: AISIN CORPORATION, Kariya (JP)

(21) Appl. No.: 19/381,481

(22) Filed: Nov. 6, 2025

(30) Foreign Application Priority Data
Jan. 30, 2025 (JP) 2025-014218
Sep. 1, 2025 (JP) 2025-144856

(51) Int. Cl. H02K 3/34; H02K 1/16; H02K 3/12

(52) U.S. Cl. CPC H02K 3/345; H02K 1/16; H02K 3/12

(57) ABSTRACT

A rotating electrical machine includes a stator core having a slot, a stator coil wound around the stator core and formed by a plurality of coil pieces, each of the plurality of coil pieces including a conductor exposed portion that is not covered with an insulating film, the conductor exposed portions being joined via a joint portion, and an insulating material portion provided so as to cover the conductor exposed portion.

### CROSS REFERENCE TO RELATED APPLICATIONS

This application is based on and claims priority under 35 U.S.C. § 119 to Japanese Patent Application Nos. 2025-014218 and 2025-144856, filed on January 30, 2025, and September 1, 2025, respectively, the entire contents of which are incorporated herein by reference.

### TECHNICAL FIELD

The present disclosure relates to a rotating electrical machine.

### BACKGROUND DISCUSSION

There is known a method of manufacturing a rotating electrical machine stator in which a rotating electrical machine workpiece in which a plurality of coil pieces forming a stator coil are attached to a stator core is prepared, the distal end portions of the plurality of coil pieces are joined to each other on one end side in an axial direction of the workpiece, a liquid resin material is applied to a target portion including the joint portion (a conductor exposed portion), and then the liquid resin material is cured, so that the joint portion is covered with an insulating material portion (a cured product of the liquid resin material) (for example, Japanese Patent Application Laid-Open No. 2016-124878).

Meanwhile, the axial length of a connecting portion of the coil piece extending in the axial direction from the axial end face of the stator core is desirably short from the viewpoint of reducing the axial size of the rotating electrical machine. In other words, the closer the axial position of the joint portion is to the axial end face of the stator core, the easier it is to reduce the axial size of the rotating electrical machine.

However, when the axial position of the joint portion is brought close to the axial end face of the stator core, the conductor exposed portion is brought close to an intersecting position of the coil pieces (a position in which the coil pieces intersect as viewed in a radial direction), and there is a problem of ensuring insulation (electrical insulation, the same is applied hereinafter). In this respect, in the configuration in which the insulating material portion is provided by the conventional method as described above, there is a problem that the insulation may be degraded at the intersecting position of the coil pieces of different phases. This is because defects such as pinholes are likely to be generated in the insulating material portion formed by curing the insulating material entering the space (the gap in the radial direction between the coil pieces) at the intersecting position. When such a defect occurs, the creepage distance between the conductor exposed portions of the paired intersecting coil pieces becomes relatively short.

A need thus exists for a rotating electrical machine which is not susceptible to the drawback mentioned above.

### SUMMARY

A rotating electrical machine includes: a stator core having a slot; a stator coil wound around the stator core and formed by a plurality of coil pieces, each of the plurality of coil pieces including a conductor exposed portion that is not covered with an insulating film, the conductor exposed portions being joined via a joint portion; and an insulating material portion provided so as to cover the conductor exposed portion. Each of the plurality of coil pieces includes a slot insertion portion inserted into the slot, an oblique portion extending in a circumferential direction and an axial direction from the slot insertion portion, and an axial end portion extending in the axial direction from the oblique portion via a bent portion. The conductor exposed portion includes the axial end portion and an end portion of the bent portion on a side close to the axial end portion. The joint portion is located at an end portion on an axially outer side of the axial end portion. The oblique portion extending from one slot toward one side in the circumferential direction and the oblique portion extending from the other slot toward the other side in the circumferential direction intersect as viewed in a radial direction. The insulating material portion is formed only in a range axially outer side of an intersection range of paired oblique portions as viewed in the radial direction in a range axially outer side of the stator core.

A rotating electrical machine includes: a stator core having a slot; a stator coil wound around the stator core and formed by a plurality of coil pieces, each of the plurality of coil pieces including a conductor exposed portion that is not covered with an insulating film, the conductor exposed portions being joined via a joint portion; and an insulating material portion provided so as to cover the conductor exposed portion. Each of the plurality of coil pieces includes a slot insertion portion inserted into the slot and an oblique portion extending in a circumferential direction and an axial direction from the slot insertion portion. The conductor exposed portion includes a distal end portion on an axially outer side of the oblique portion. The joint portion is located at the distal end portion. The oblique portion extending from one slot toward one side in the circumferential direction and the oblique portion extending from the other slot toward the other side in the circumferential direction intersect as viewed in a radial direction. The insulating material portion is formed only in a range axially outer side of an intersection range of paired oblique portions as viewed in the radial direction in a range axially outer side of the stator core.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view schematically illustrating a cross-sectional structure of a motor according to an embodiment;

FIG. 2 is a plan view of a stator core in a single item state;

FIG. 3 is a diagram schematically illustrating a pair of coil pieces assembled to the stator core;

FIG. 4 is a schematic front view of one coil piece;

FIG. 5A is a schematic diagram illustrating a configuration of a joint portion between the coil pieces of the present embodiment and a periphery thereof, and is a diagram illustrating two pairs of coil pieces as viewed in a radial direction;

FIG. 5B is a diagram illustrating a state where an insulating material portion is removed from FIG. 5A;

FIG. 6 is a diagram illustrating a coil piece according to a comparative example in the same view as FIG. 5A;

FIG. 7 is a cross-sectional view taken along line VII-VII in FIG. 5A, and is a cross-sectional view of a distal end portion;

FIG. 8 is a cross-sectional view taken along line VIII-VIII in FIG. 5A;

FIG. 9 is a cross-sectional view taken along line IV-IV in FIG. 5A;

FIG. 10 is a diagram illustrating the view illustrated in FIG. 5A for a configuration according to the comparative example;

FIG. 11 is a cross-sectional view taken along line XI-XI in FIG. 10;

FIG. 12 is an explanatory diagram of a reduced creepage distance in the comparative example;

FIG. 13 is an explanatory diagram of a modification; and

FIG. 14 is a cross-sectional view taken along line XIV-XIV in FIG. 13.

### DESCRIPTION OF EMBODIMENTS

Hereinafter, each embodiment will be described in detail with reference to the drawings. Note that the dimensional ratios in the drawings are merely examples, and the dimensional ratios are not limited thereto, and shapes and the like in the drawings may be partially exaggerated for convenience of description. In addition, in the drawings, only some of a plurality of portions having the same attribute may be denoted by reference numerals for the sake of clarity. Furthermore, in a comparative example, components that may be the same as those in the embodiment are denoted by the same reference numerals, and description thereof may be omitted.

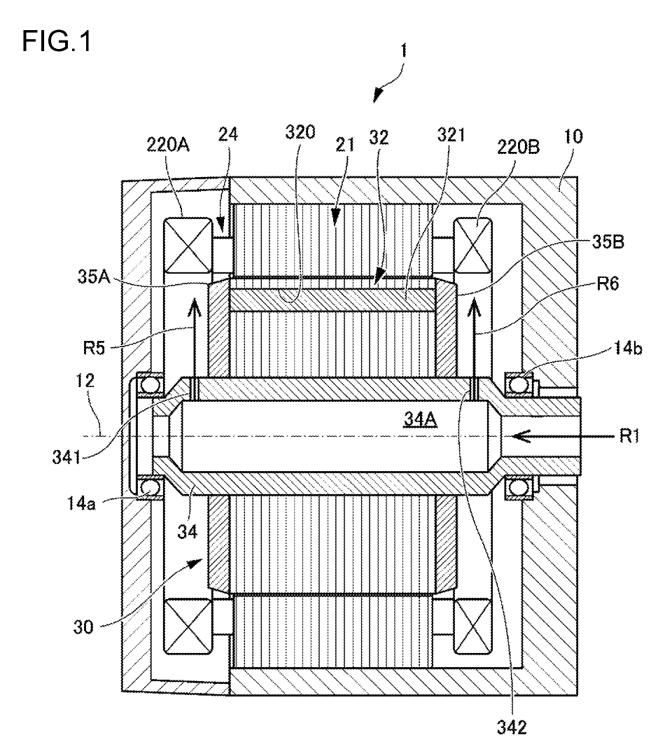

FIG. 1 is a cross-sectional view schematically illustrating a cross-sectional structure of a motor 1 (an example of a rotating electrical machine) according to an embodiment.

FIG. 1 illustrates a rotation axis 12 of the motor 1. In the following description, the axial direction refers to a direction in which the rotation axis (the rotation center) 12 of the motor 1 extends, and the radial direction refers to a radial direction around the rotation axis 12. Therefore, the radially outer side refers to a side away from the rotation axis 12, and the radially inner side refers to a side toward the rotation axis 12. In addition, the circumferential direction corresponds to a rotation direction around the rotation axis 12.

The motor 1 may be, for example, a vehicle drive motor used in a hybrid vehicle or an electric vehicle. Here, the motor 1 may be used for any other application.

The motor 1 is an inner rotor type, and is provided in a manner that a stator 21 surrounds the radially outer side of a rotor 30. The radially outer side of the stator 21 is fixed to a motor housing 10.

The rotor 30 is disposed on the radially inner side of the stator 21. The rotor 30 includes a rotor core 32 and a rotor shaft 34. The rotor core 32 is fixed to the radially outer side of the rotor shaft 34 and rotates integrally with the rotor shaft 34. The rotor shaft 34 is rotatably supported by the motor housing 10 via bearings 14a and 14b. Note that the rotor shaft 34 defines the rotation axis 12 of the motor 1.

The rotor core 32 is made of, for example, annular magnetic laminated steel plates. A permanent magnet 321 is inserted into a magnet hole 320 of the rotor core 32. The number, arrangement, and the like of the permanent magnets 321 are arbitrary. In a modification, the rotor core 32 may be formed of a green compact obtained by compressing and solidifying magnetic powder.

End plates 35A and 35B are attached to both sides in the axial direction of the rotor core 32. The end plates 35A and 35B may have a function of adjusting the imbalance of the rotor 30 (a function of eliminating the imbalance by cutting or the like) in addition to a support function of supporting the rotor core 32.

As illustrated in FIG. 1, the rotor shaft 34 has a hollow portion 34A. The hollow portion 34A extends over the entire length in the axial direction of the rotor shaft 34. The hollow portion 34A may function as an oil passage. For example, as indicated by an arrow R1 in FIG. 1, oil is supplied to the hollow portion 34A from one end side in the axial direction, and the oil flows along the radially inner surface of the rotor shaft 34, so that the rotor core 32 can be cooled from the radially inner side. Furthermore, the oil flowing along the radially inner surface of the rotor shaft 34 may be ejected radially outward through oil holes 341 and 342 formed at both end portions of the rotor shaft 34 (arrows R5 and R6) to be used for cooling coil ends 220A and 220B.

Note that, although FIG. 1 illustrates the motor 1 with a specific structure, the structure of the motor 1 is arbitrary as long as the motor 1 includes a stator coil 24 (described later) joined by welding. Therefore, for example, the rotor shaft 34 need not have the hollow portion 34A, or may have a hollow portion with a significantly smaller inner diameter than the hollow portion 34A. Furthermore, although a specific cooling method is disclosed in FIG. 1, the method of cooling the motor 1 is arbitrary. Therefore, for example, an oil introduction pipe inserted into the hollow portion 34A may be provided, or oil may be dropped from the oil passage in the motor housing 10 toward the coil ends 220A and 220B from the radially outer side.

Moreover, the inner rotor type motor 1 in which the rotor 30 is disposed inside the stator 21 is illustrated in FIG. 1, but the present disclosure may be applied to a motor of another form. For example, the present disclosure may be applied to an outer rotor type motor in which the rotor 30 is concentrically disposed outside the stator 21, a dual rotor type motor in which the rotor 30 is disposed both outside and inside the stator 21, and the like.

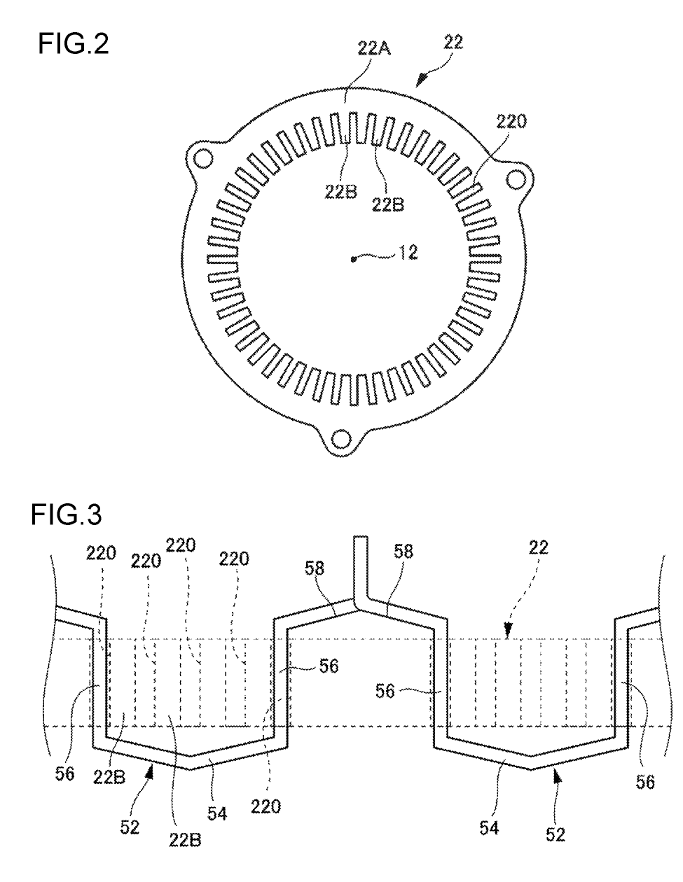

Next, a configuration related to the stator 21 will be described in detail with reference to FIG. 2 and subsequent drawings.

FIG. 2 is a plan view of a stator core 22 in a single item state. FIG. 3 is a diagram schematically illustrating a pair of coil pieces 52 assembled to the stator core 22. FIG. 3 illustrates the relationship between the pair of coil pieces 52 and a slot 220 in a state where the radially inner side of the stator core 22 is developed. Furthermore, in FIG. 3, the stator core 22 is indicated by a dotted line, and some of the slots 220 are not illustrated.

The stator 21 includes the stator core 22 and the stator coil 24.

The stator core 22 is made of, for example, annular magnetic laminated steel plates, but in a modification, the stator core 22 may be formed of a green compact obtained by compressing and solidifying magnetic powder. Note that the stator core 22 may be formed by split cores split in the circumferential direction, or may be in a form not split in the circumferential direction. A plurality of slots 220 around which the stator coil 24 is wound are formed on the radially inner side of the stator core 22. Specifically, as illustrated in FIG. 2, the stator core 22 includes an annular back yoke 22A and a plurality of teeth 22B extending radially inward from the back yoke 22A, and the slots 220 are formed between the plurality of teeth 22B in the circumferential direction. The number of slots 220 is arbitrary, but is 48 in the present embodiment as an example.

The stator coil 24 includes a U-phase coil, a V-phase coil, and a W-phase coil (hereinafter, the U-phase coil, the V-phase coil, and the W-phase coil will be referred to as “phase coils” when U, V, and W are not distinguished). The proximal end of each phase coil is connected to an input terminal (not illustrated), and the terminal end of each phase coil is connected to the terminal end of another phase coil to form a neutral point of the motor 1. That is, the stator coil 24 is star-connected. Here, the connection mode of the stator coil 24 may be changed as appropriate depending on required motor characteristics and the like, and for example, the stator coil 24 may be delta-connected instead of being star-connected.

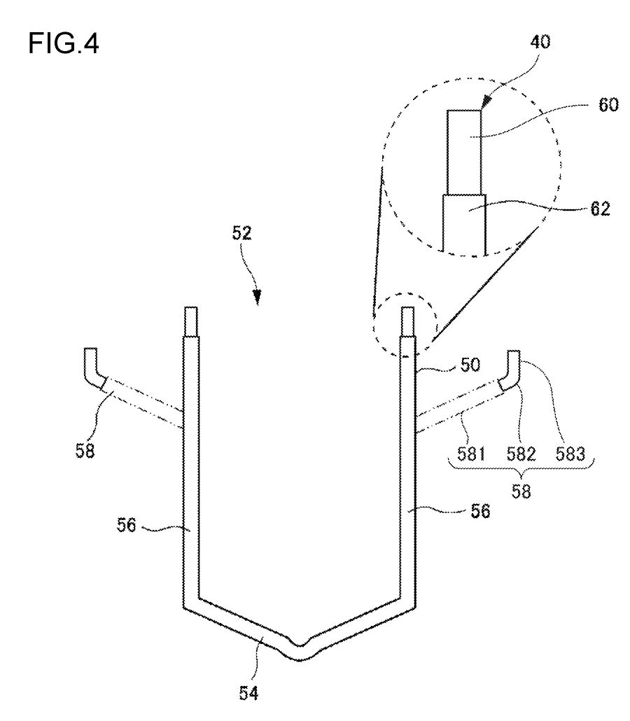

Each phase coil is formed by joining a plurality of coil pieces 52. FIG. 4 is a schematic front view of one coil piece 52. The coil piece 52 is in the form of a segment coil obtained by dividing the phase coil into units that are easy to assemble (for example, units to be inserted into the two slots 220). The coil piece 52 is formed by coating a linear conductor (a rectangular wire) 60 with a rectangular cross-section with an insulating film 62. In the present embodiment, the linear conductor 60 is made of copper, for example. Here, in the modification, the linear conductor 60 may be made of another conductor material such as iron. Note that, in the following description, the coil pieces 52 of different phases refer to the coil pieces 52 of different phases such as the U-phase and the V-phase.

Before being assembled to the stator core 22, the coil piece 52 may be formed in a substantially U-shape having a pair of straight portions 50 and a coupling portion 54 that couples the pair of straight portions 50. When the coil piece 52 is assembled to the stator core 22, each of the pair of straight portions 50 is inserted into the slot 220 (see FIG. 3). As a result, as illustrated in FIG. 3, the coupling portion 54 extends over the plurality of teeth 22B (and the plurality of slots 220 accordingly) in the circumferential direction on the other end side in the axial direction of the stator core 22. The number of slots 220 over which the coupling portion 54 extends is arbitrary, but is three in FIG. 3. Furthermore, after being inserted into the slot 220, the straight portion 50 is bent midway in the circumferential direction as indicated by a two-dot chain line in FIG. 4. As a result, the straight portion 50 becomes a slot insertion portion 56 extending in the axial direction in the slot 220 and a connecting portion 58 extending in the circumferential direction on one end side in the axial direction of the stator core 22. Note that the connecting portion 58 forms the coil end 220A.

Note that, in FIG. 4, the paired straight portions 50 are bent in directions away from each other, but it is not limited thereto. For example, the paired straight portions 50 may be bent in directions approaching each other. In addition, the stator coil 24 may also have a neutral point coil piece or the like for coupling terminal ends of three-phase coils to form a neutral point.

A plurality of slot insertion portions 56 of the coil pieces 52 illustrated in FIG. 4 are inserted into one slot 220 side by side in the radial direction. Therefore, a plurality of connecting portions 58 extending in the circumferential direction are arranged in the radial direction on one end side in the axial direction of the stator core 22. As illustrated in FIG. 3, the connecting portion 58 of one coil piece 52 that protrudes from one slot 220 and extends toward the circumferential first side (for example, the clockwise direction) is joined to the connecting portion 58 of the other coil piece 52 that protrudes from the other slot 220 and extends toward the circumferential second side (for example, the counterclockwise direction).

In the present embodiment, as an example, the connecting portion 58 has an oblique portion 581 extending axially outward and in the circumferential direction, a bent R portion 582, and an axial end portion 583 extending in the axial direction.

In the present embodiment, as an example, six coil pieces 52 are assembled to one slot 220. Hereinafter, the coil pieces are also referred to as a first turn coil piece, a second turn coil piece, and a third turn coil piece in order from the outermost coil piece 52 in the radial direction. In this case, distal end portions 40 of the first turn coil piece 52 and the second turn coil piece 52 are joined to each other in a joining step, the distal end portions 40 of the third turn coil piece 52 and the fourth turn coil piece 52 are joined to each other in the joining step, and the distal end portions 40 of the fifth turn coil piece 52 and the sixth turn coil piece 52 are joined to each other in the joining step.

The joining step may be performed by any method, for example, welding, or may be performed by a method other than welding (for example, brazing). Furthermore, the joining range is the distal end portion 40 of the axial end portion 583, but details such as the size thereof are arbitrary.

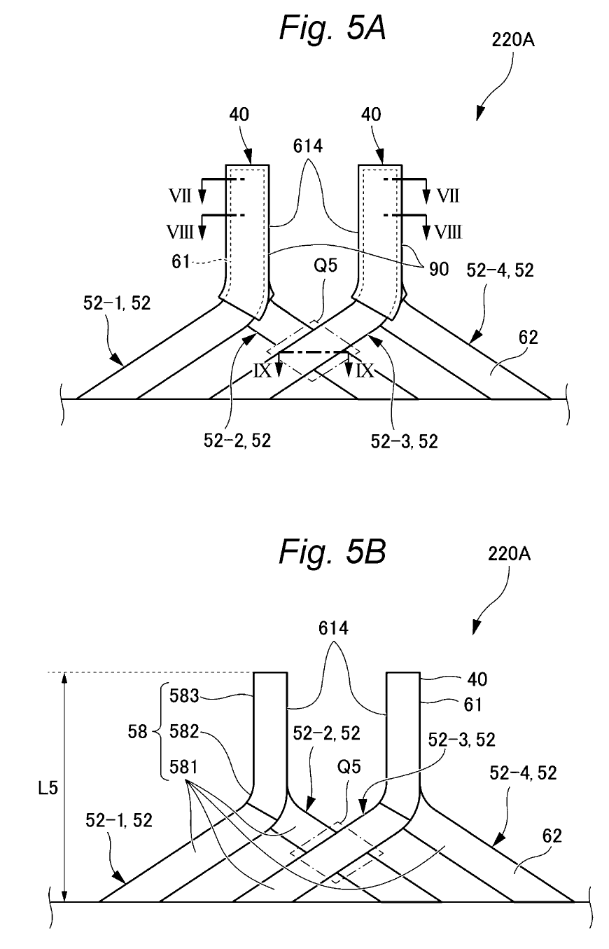

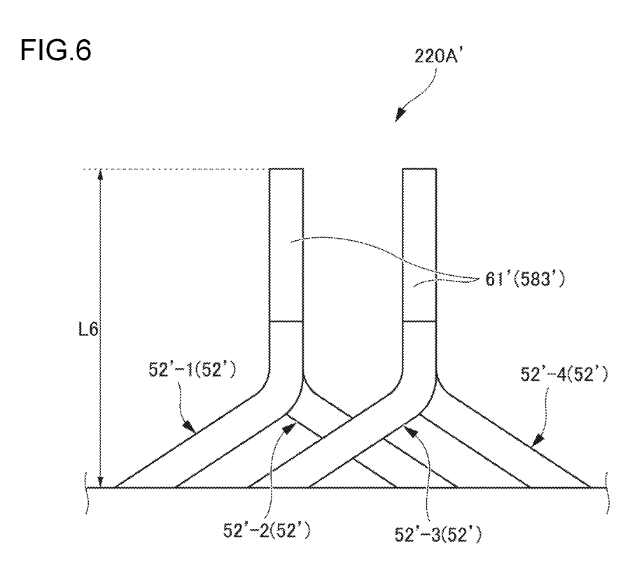

FIG. 5A is a schematic diagram illustrating a configuration of a joint portion between the coil pieces 52 of the present embodiment and a periphery thereof, and is a diagram illustrating two pairs of coil pieces 52 as viewed in the radial direction. FIG. 5B is a diagram illustrating a state where an insulating material portion 90 is removed from FIG. 5A. FIG. 6 is a diagram illustrating a coil piece 52’ according to a comparative example in the same view as FIG. 5A. In FIG. 6, the insulating material portion 90 is not illustrated as in FIG. 5B.

Here, as described above, the coil piece 52 is covered with the insulating film 62, but the insulating film 62 is removed in the axial end portion 583 and the like including the distal end portion 40. This is to ensure electrical connection with the other coil piece 52 at the distal end portion 40 of the axial end portion 583. The cut line of the insulating film 62 is arbitrary, but may be set in a plane in which the extending direction of the linear conductor 60 of the corresponding portion is the normal direction.

In the present embodiment, the portion (hereinafter, also referred to as “conductor exposed portion 61”) in which the linear conductor 60 is exposed includes the axial end portion 583 and a part of the bent R portion 582 (an end portion on the axial end portion 583 side). Here, in the modification, the conductor exposed portion 61 may include the axial end portion 583 and the entire bent R portion 582. Note that, in the present embodiment, a cut line of the insulating film 62 is present in the bent R portion 582, and the cut line is along the radial direction of the R-shape of the bent R portion 582.

By starting the conductor exposed portion 61 from a part of the bent R portion 582 (or the entire bent R portion 582) as described above, it is possible to reduce the axial length L5 (see FIG. 5B) of the coil end 220A as compared with the comparative example illustrated in FIG. 6. Specifically, in the comparative example illustrated in FIG. 6, a conductor exposed portion 61’ is only the distal end portion of an axial end portion 583’. In this case, the axial length of the axial end portion 583’ is relatively long and the axial length L6 of a coil end 220A’ is relatively long. Note that the conductor exposed portion 61’ (the same applies to the conductor exposed portion 61) needs to have a certain length or more. On the other hand, according to the present embodiment, by starting the conductor exposed portion 61 from the bent R portion 582, the axial end portion 583 can be relatively shortened. As a result, the axial length of the coil end 220A can be reduced, and the axial size of the motor 1 can be reduced.

In the present embodiment, as schematically illustrated in FIG. 5A, the insulating material portion 90 is provided so as to cover the conductor exposed portion 61. The insulating material portion 90 may be any insulating material such as a resin material, and may contain a filler or the like. The insulating material portion 90 may be formed by, for example, electrodeposition coating. In this case, the insulating material portion 90 can be efficiently formed on the conductor exposed portion 61.

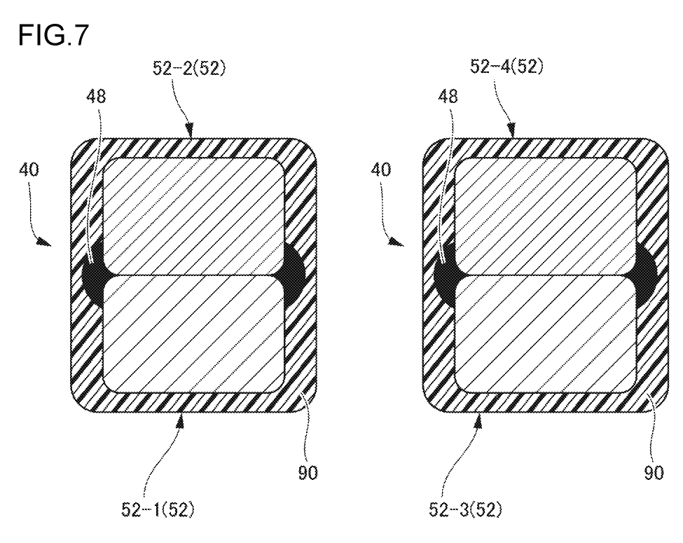

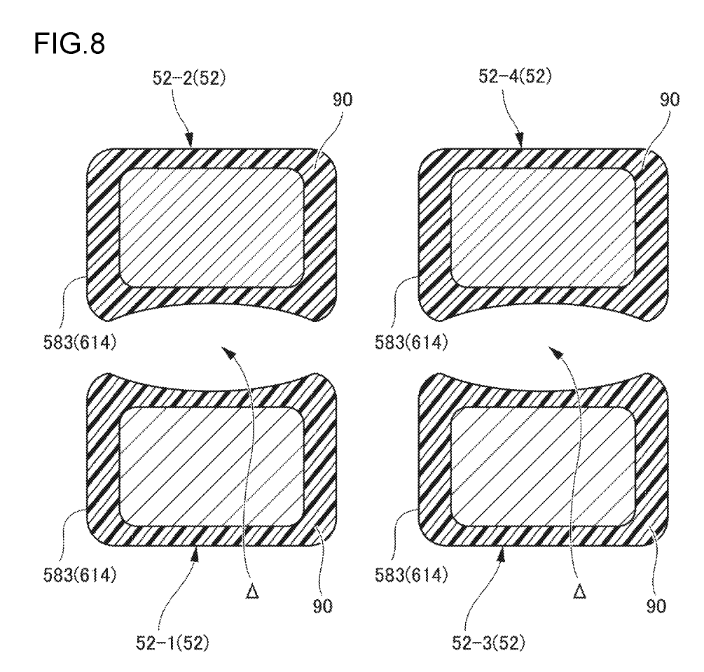

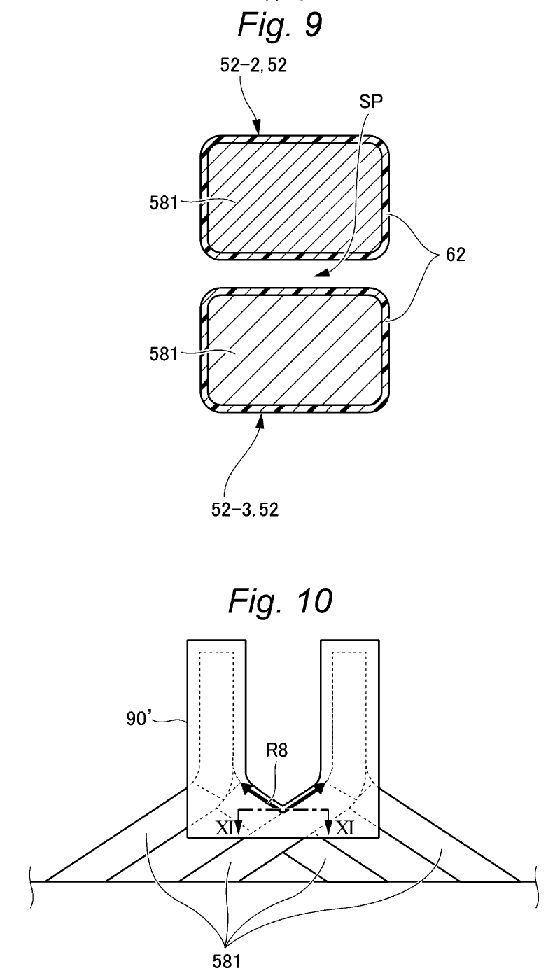

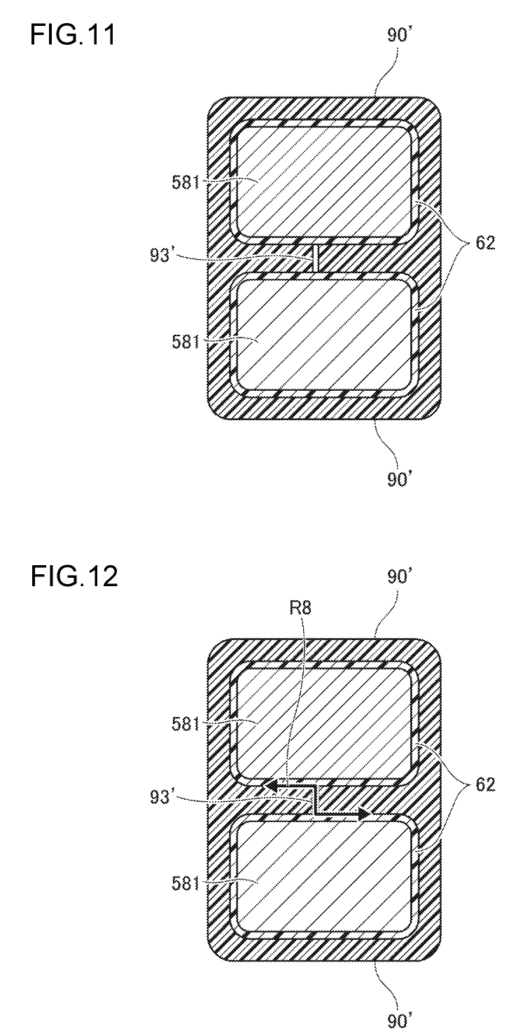

FIG. 7 is a cross-sectional view taken along line VII-VII in FIG. 5A, and is a cross-sectional view of the distal end portion 40. FIG. 8 is a cross-sectional view taken along line VIII-VIII in FIG. 5A. FIG. 9 is a cross-sectional view taken along line IV-IV in FIG. 5A. FIG. 10 is a diagram illustrating the view illustrated in FIG. 5A for a configuration according to the comparative example. FIG. 11 is a cross-sectional view taken along line XI-XI in FIG. 10. FIG. 12 is an explanatory diagram of a reduced creepage distance in the comparative example.

In FIGS. 7 and 8, two pairs of coil pieces 52 joined to each other are illustrated. In this case, the individual coil pieces 52 forming the two pairs of coil pieces 52 are also referred to as a coil piece 52-1, a coil piece 52-2, a coil piece 52-3, and a coil piece 52-4 when distinguished. Furthermore, in the view illustrated in FIG. 8, the sides of the two axial end portions 583 facing each other are also referred to as “facing sides”, and the opposite sides are also referred to as “non-facing sides” hereinafter.

As described above, the coil piece 52-1 and the coil piece 52-2 are joined to each other in a manner that the distal end portions 40 of the axial end portions 583 are joined to each other. The same applies to the other pair of the coil piece 52-3 and the coil piece 52-4. Note that, as illustrated in FIG. 7, the distal end portions 40 are joined to each other via a welded portion 48 on the side (circumferential side) of the mating surface, but may be joined to each other via a similar welded portion on the axially outer side of the mating surface instead of or in addition to the welded portion 48.

In the present embodiment, the joint portion of the conductor exposed portion 61 to be joined is not the entire conductor exposed portion 61 but the distal end portion 40 of the axial end portion 583. Therefore, the surfaces of non-joint portions 614 of the conductor exposed portions 61 on the facing side are separated from each other as illustrated in FIG. 8. The paired non-joint portions 614 of the paired axial end portions 583 to be joined extend in the axial direction in a manner of radially facing each other. Note that the non-joint portion 614 is a portion of the conductor exposed portion 61 excluding the joint portion, and specifically includes a portion of the axial end portion 583 excluding the distal end portion 40 and the bent R portion 582 (see FIG. 5A).

In the present embodiment, the insulating material portion 90 is formed on the paired non-joint portions 614 in a manner that a gap Δ is formed on the facing side. That is, the insulating material portion 90 formed on the non-joint portion 614 of the coil piece 52-1 and the insulating material portion 90 formed on the non-joint portion 614 of the coil piece 52-2 are not integrated with each other, and the gap Δ is formed on the facing side. The same applies to the other pair of the coil piece 52-3 and the coil piece 52-4.

In the present embodiment, as described above, the gap Δ of the insulating material portion 90 is formed between the facing sides of the paired non-joint portions 614. As a result, oil can reach the gap Δ, and the cooling performance of the conductor exposed portion 61 can be enhanced. In addition, the amount of material used to form the insulating material portion 90 can be relatively small, and the material cost can be reduced.

Note that the gap Δ need not be formed over the entire non-joint portion 614, and may be formed at least on the root side (the axially inner side) of the non-joint portion 614. That is, the gap Δ need not be formed in a portion of the non-joint portion 614 adjacent to the joint portion.

Meanwhile, in the coil end 220A, as indicated by a range Q5 in FIG. 5A, the oblique portion 581 extending from one slot 220 toward one side in the circumferential direction and the oblique portion 581 extending from the other slot 220 toward the other side in the circumferential direction intersect as viewed in the radial direction. That is, in FIG. 5A, the oblique portions 581 of the coil piece 52-2 and the coil piece 52-3 intersect each other when viewed in the radial direction. Hereinafter, the paired intersecting oblique portions 581 are also simply referred to as “paired oblique portions 581”.

In the present embodiment, as illustrated in FIG. 9, the insulating material portion 90 is formed in a manner that a space SP is formed between the paired oblique portions 581 in the radial direction. Such a space SP may be formed over the entire intersection range (see Q5 in FIG. 5A). The intersection range does not include the bent R portion 582 and the conductor exposed portion 61. That is, the portion of the coil piece 52 within the intersection range is located axially inside the bent R portion 582. Note that the paired oblique portions 581 include the insulating film 62 in the intersection range (see Q5 in FIG. 5A), and the insulating material portion 90 is not applied thereto. Therefore, the insulating material portion 90 applied to the coil piece 52 of one phase and the insulating material portion 90 applied to the coil piece 52 of another phase are not integrated (connected). That is, the insulating material portion 90 is formed on the axially outer side of the paired oblique portions so as not to overlap the paired oblique portions 581 of the paired non-joint portions 614 as viewed in the radial direction.

Here, in the comparative example, as illustrated in FIGS. 10 and 11, an insulating material portion 90’ is also formed between the paired oblique portions 581 in the radial direction. In this case, the insulating material portion 90’ applied to the coil piece 52 of one phase and the insulating material portion 90’ applied to the coil piece 52 of another phase are integrated (connected). When a defect 93’ (see FIG. 11) such as a pinhole is formed in the insulating material portion 90’ formed at such a position, as schematically indicated by an arrow R8 in FIGS. 10 and 12, the creepage distance between the paired conductor exposed portions 61 continuous from the paired oblique portions 581 may be reduced. As a result, insulation between the coil pieces 52 of different phases may be degraded.

On the other hand, according to the present embodiment, as described above, since the space SP is formed between the paired oblique portions 581 in the radial direction, it is possible to prevent the inconvenience caused in the comparative example (the decrease in insulation due to the decrease in creepage distance).

In particular, in the present embodiment, in the paired oblique portions 581, the surfaces of the rectangular wires face each other in the radial direction, and the surfaces facing each other in the radial direction are flat portions of the rectangular wires (flat portions excluding the portions of corners R). In the paired oblique portions 581, the flat portions are closer to each other in the radial direction than the portions of the corners R. Therefore, in the present embodiment, since the closest portions are not connected via the insulating material portion 90, high insulation performance can be ensured.

Although each embodiment has been described in detail above, the present disclosure is not limited to a specific embodiment, and various modifications and changes can be made within the scope described in the claims. In addition, all or a plurality of the components of the embodiments described above can be combined.

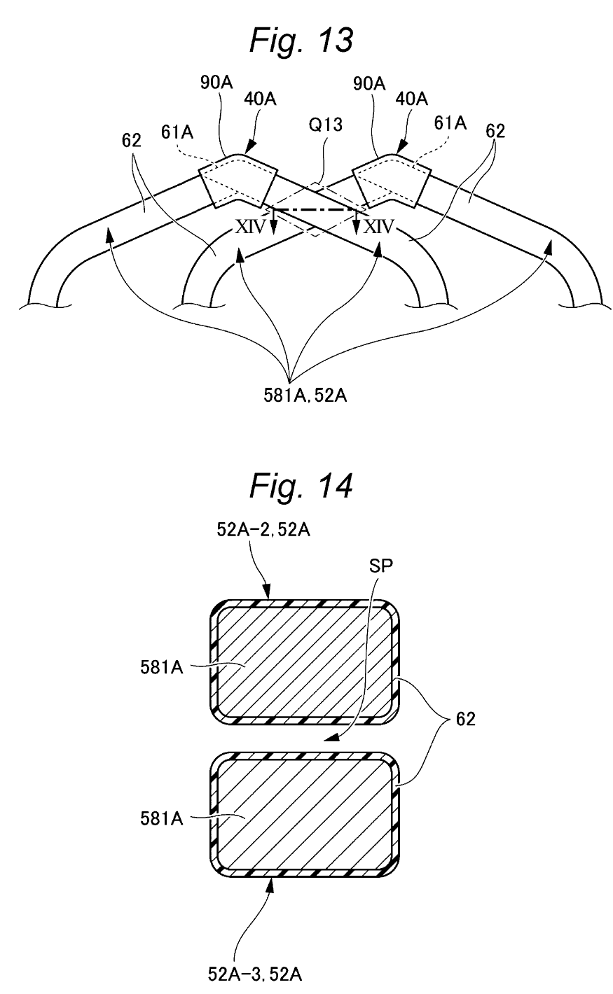

For example, in the embodiment described above, the coil piece 52 includes the axial end portion 583, but it is not limited thereto. That is, the form of the joint portion of the coil piece 52 is arbitrary. For example, in the modification illustrated in FIG. 13, a coil piece 52A does not have the axial end portion 583, and distal end portions 40A on the axially outer sides of oblique portions 581A are joined to each other. As a result, the axial length of the coil end can be reduced, and the axial size of the motor can be reduced. In this case, a conductor exposed portion 61A includes the distal end portion 40A (the joint portion) on the axially outer side of the oblique portion 581A, but also includes a portion other than the joint portion (a portion of the oblique portion 581A on the axially inner side continuous from the distal end portion 40A). Even in such a configuration, by not forming the insulating material portion 90A between the paired oblique portions 581A in the radial direction, it is possible to obtain similar effects to those in the embodiment described above. That is, the paired oblique portions 581A each include the insulating film 62 in the intersection range (see Q13 in FIG. 13), and the insulating material portion 90A is not applied thereto. Therefore, also in the present modification, the insulating material portion 90A applied to the coil piece 52A of one phase and the insulating material portion 90A applied to the coil piece 52A of another phase are not integrated (connected).

A rotating electrical machine includes: a stator core having a slot; a stator coil wound around the stator core and formed by a plurality of coil pieces, each of the plurality of coil pieces including a conductor exposed portion that is not covered with an insulating film, the conductor exposed portions being joined via a joint portion; and an insulating material portion provided so as to cover the conductor exposed portion. Each of the plurality of coil pieces includes a slot insertion portion inserted into the slot, an oblique portion extending in a circumferential direction and an axial direction from the slot insertion portion, and an axial end portion extending in the axial direction from the oblique portion via a bent portion. The conductor exposed portion includes the axial end portion and an end portion of the bent portion on a side close to the axial end portion. The joint portion is located at an end portion on an axially outer side of the axial end portion. The oblique portion extending from one slot toward one side in the circumferential direction and the oblique portion extending from the other slot toward the other side in the circumferential direction intersect as viewed in a radial direction. The insulating material portion is formed only in a range axially outer side of an intersection range of paired oblique portions as viewed in the radial direction in a range axially outer side of the stator core.

In one aspect, according to the present disclosure, it is possible to appropriately provide the insulating material portion on the conductor exposed portion including the joint portion.

In the rotating electrical machine, the plurality of coil pieces are formed of rectangular wires with a rectangular cross-section, in paired oblique portions intersecting with each other as viewed in a radial direction, surfaces of rectangular wires face each other in the radial direction, and the insulating material portion is not formed between the surfaces facing each other in the radial direction.

In the rotating electrical machine, the rectangular cross-section has a corner R, and the surfaces facing each other in a radial direction are flat portions excluding a portion of the corner R.

In the rotating electrical machine, a portion of the insulating material portion applied to the bent portion from one of paired oblique portions extending from two slots adjacent to each other in a circumferential direction toward a same side in the circumferential direction is separated from the other oblique portion.

A rotating electrical machine includes: a stator core having a slot; a stator coil wound around the stator core and formed by a plurality of coil pieces, each of the plurality of coil pieces including a conductor exposed portion that is not covered with an insulating film, the conductor exposed portions being joined via a joint portion; and an insulating material portion provided so as to cover the conductor exposed portion. Each of the plurality of coil pieces includes a slot insertion portion inserted into the slot and an oblique portion extending in a circumferential direction and an axial direction from the slot insertion portion. The conductor exposed portion includes a distal end portion on an axially outer side of the oblique portion. The joint portion is located at the distal end portion. The oblique portion extending from one slot toward one side in the circumferential direction and the oblique portion extending from the other slot toward the other side in the circumferential direction intersect as viewed in a radial direction. The insulating material portion is formed only in a range axially outer side of an intersection range of paired oblique portions as viewed in the radial direction in a range axially outer side of the stator core.

In the rotating electrical machine, an intersection range of paired oblique portions as viewed in a radial direction does not include the conductor exposed portion.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotating electrical machine comprising:
a stator core having a slot;
a stator coil wound around the stator core and formed by a plurality of coil pieces, each of the plurality of coil pieces including a conductor exposed portion that is not covered with an insulating film, the conductor exposed portions being joined via a joint portion; and
an insulating material portion provided so as to cover the conductor exposed portion, wherein
each of the plurality of coil pieces includes a slot insertion portion inserted into the slot, an oblique portion extending in a circumferential direction and an axial direction from the slot insertion portion, and an axial end portion extending in the axial direction from the oblique portion via a bent portion,
the conductor exposed portion includes the axial end portion and an end portion of the bent portion on a side close to the axial end portion,
the joint portion is located at an end portion on an axially outer side of the axial end portion,
the oblique portion extending from one slot toward one side in the circumferential direction and the oblique portion extending from the other slot toward the other side in the circumferential direction intersect as viewed in a radial direction, and
the insulating material portion is formed only in a range axially outer side of an intersection range of paired oblique portions as viewed in the radial direction in a range axially outer side of the stator core.

2. The rotating electrical machine according to claim 1, wherein the plurality of coil pieces are formed of rectangular wires with a rectangular cross-section,
in paired oblique portions intersecting with each other as viewed in a radial direction, surfaces of rectangular wires face each other in the radial direction, and
the insulating material portion is not formed between the surfaces facing each other in the radial direction.

3. The rotating electrical machine according to claim 1, wherein the rectangular cross-section has a corner R, and
the surfaces facing each other in a radial direction are flat portions excluding a portion of the corner R.

4. The rotating electrical machine according to claim 1, wherein a portion of the insulating material portion applied to the bent portion from one of paired oblique portions extending from two slots adjacent to each other in a circumferential direction toward a same side in the circumferential direction is separated from the other oblique portion.

5. A rotating electrical machine comprising:
a stator core having a slot;
a stator coil wound around the stator core and formed by a plurality of coil pieces, each of the plurality of coil pieces including a conductor exposed portion that is not covered with an insulating film, the conductor exposed portions being joined via a joint portion; and
an insulating material portion provided so as to cover the conductor exposed portion, wherein
each of the plurality of coil pieces includes a slot insertion portion inserted into the slot and an oblique portion extending in a circumferential direction and an axial direction from the slot insertion portion,
the conductor exposed portion includes a distal end portion on an axially outer side of the oblique portion,
the joint portion is located at the distal end portion,
the oblique portion extending from one slot toward one side in the circumferential direction and the oblique portion extending from the other slot toward the other side in the circumferential direction intersect as viewed in a radial direction, and
the insulating material portion is formed only in a range axially outer side of an intersection range of paired oblique portions as viewed in the radial direction in a range axially outer side of the stator core.

6. The rotating electrical machine according to claim 1, wherein an intersection range of paired oblique portions as viewed in a radial direction does not include the conductor exposed portion.

7. The rotating electrical machine according to claim 2, wherein an intersection range of paired oblique portions as viewed in a radial direction does not include the conductor exposed portion.

8. The rotating electrical machine according to claim 3, wherein an intersection range of paired oblique portions as viewed in a radial direction does not include the conductor exposed portion.

9. The rotating electrical machine according to claim 4, wherein an intersection range of paired oblique portions as viewed in a radial direction does not include the conductor exposed portion.

10. The rotating electrical machine according to claim 5, wherein an intersection range of paired oblique portions as viewed in a radial direction does not include the conductor exposed portion.
